(19) United States
(12) Patent Application Publication
(10) Pub. No.: US 2007/0255722 A1
(43) Pub. Date: Nov. 1, 2007

(54) Data-driven page layout

(75) Inventors: Jonathan B. Leffert, Mountain View, CA (US); Ellis Verosub, San Francisco, CA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Computer, Inc.

(21) Appl. No.: 11/414,494

(22) Filed: Apr. 28, 2006

(51) Int. Cl. G06F 17/30

(52) U.S. Cl. 707/10

(57) ABSTRACT

Data driven page layout is disclosed. In some embodiments, an instance of a display page is created based at least in part on a display page structure derived from a previously-created display page at least in part by extracting from the previously-created display page one or more structural objects of the previously-created display page and one or more structural relationships between them, but not corresponding content of the previously-created display page, and an editing interface is provided that is configured to enable the instance of the display page to be edited at least in part by manipulating, within a graphical representation of a current structure of the display page, a graphical representation of a structural object comprising the display page.

### BACKGROUND OF THE INVENTION

Custom coding display pages in a language such as XML often requires considerable time as well as knowledge of the language. Typically, templates based upon code may be used to facilitate the process of creating display pages. However, the use of such templates still requires a code build, which takes time and may require some knowledge of the code, for example, if a problem is encountered during the build.

Thus, there is a need for a more efficient way of creating display pages.

### BRIEF DESCRIPTION OF THE DRAWINGS

Various embodiments of the invention are disclosed in the following detailed description and the accompanying drawings.

FIG. 1 illustrates an embodiment of a network environment.

FIG. 2 illustrates an embodiment of a web page.

. 3 illustrates an embodiment of a process for creating a template of a display page.

FIG. 4 illustrates an embodiment of a template of web page 200 of FIG. 2 in a graphical manner.

FIG. 5 illustrates an embodiment of a hierarchical object graph of web page 200 of FIG. 2.

FIG. 6 illustrates an embodiment of a process for creating an instance of a display page from a template.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A object such as a processor or a memory described as being configured to perform a task includes both a general object that is temporarily configured to perform the task at a given time or a specific object that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Data driven page layout is disclosed. In some embodiments, an instance of a display page is created based at least in part on a display page structure derived from a previously-created display page at least in part by extracting from the previously-created display page one or more structural objects of the previously-created display page and one or more structural relationships between them, but not corresponding content of the previously-created display page, and an editing interface is provided that is configured to enable the instance of the display page to be edited at least in part by manipulating, within a graphical representation of a current structure of the display page, a graphical representation of a structural object comprising the display page.

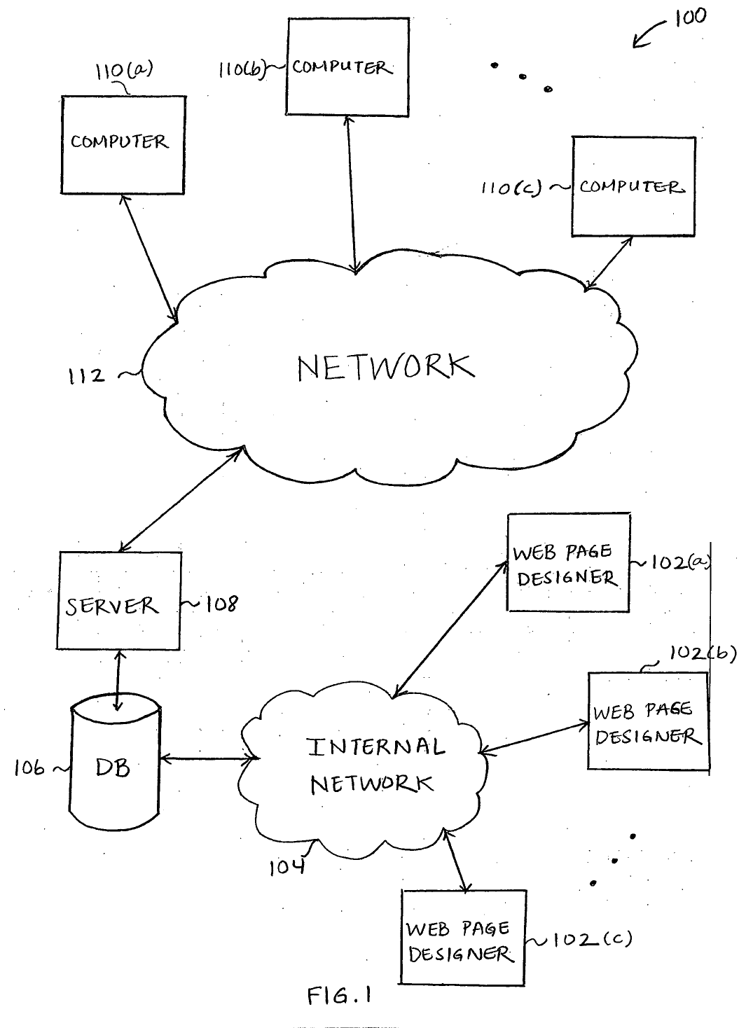

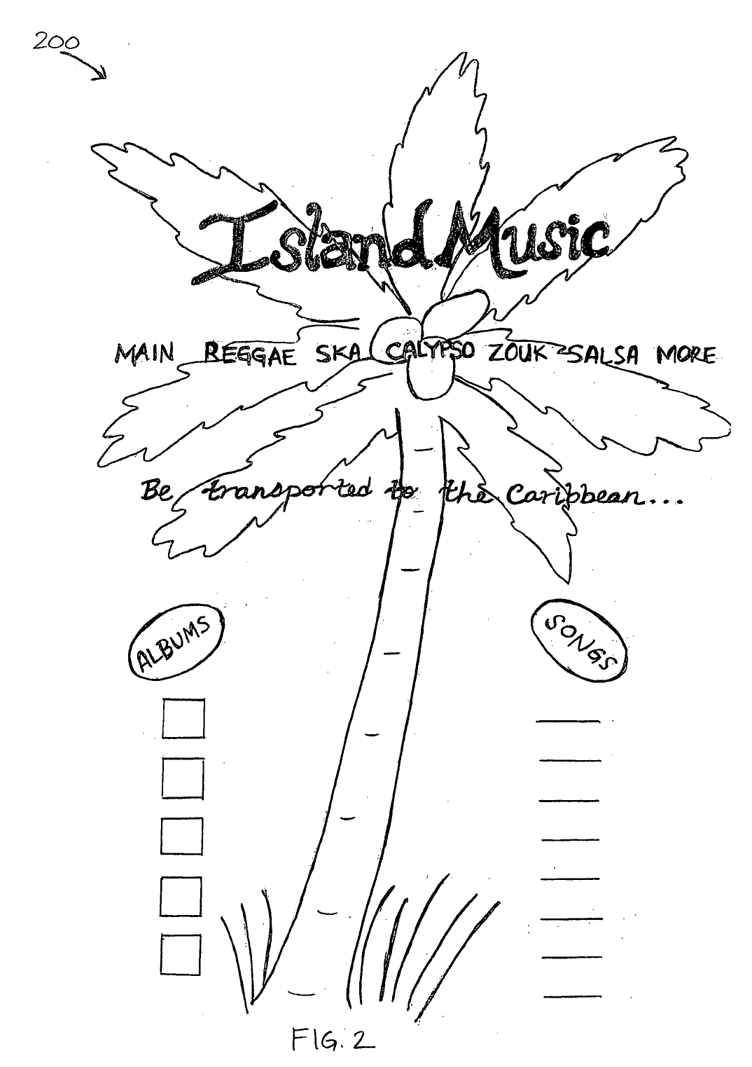

FIG. 1 illustrates an embodiment of a network environment. As depicted, network environment 100 includes computers associated with a group of web page designers 102 that are interconnected by a private, internal network 104. Internal network 104 facilitates communication between the web page designers 102 as well as access to a database 106. The sharing of files and data among the group of web page designers 102 is facilitated at least in part by use of a shared database 106. Web page designers 102 employ database 106 for the storage and retrieval of files and data during web page and web site design and development. Web pages created by web page designers 102 and associated content are persisted in database 106 and are either directly (as shown in FIG. 1) or indirectly (via another component such as a business logic application or server) accessible by a server 108 from database 106. When requested, server 108 may retrieve a web page, if available, from database 106 and provide the requested web page to a requesting computer 110. For example, web pages from database 106 may be made available by server 108 to a computer 110 as the user of computer 110 navigates through a web site hosted by server 108. In some embodiments, server 108 corresponds to an application server, and a local client of application server 108 at a computer 110 facilitates access to a web site and associated web pages hosted by application server 108. Computers 1O communicate with server 108 over network 11 2. Network 112 corresponds to any private or public network, such as a LAN, WAN, the Internet, etc.

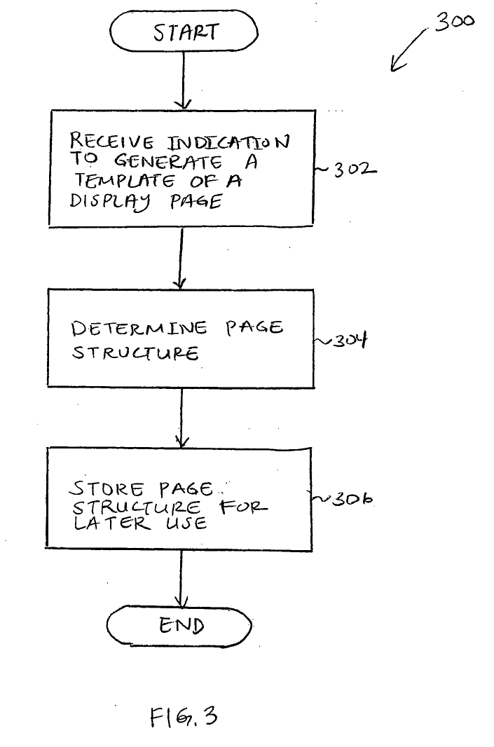

FIG. 2 illustrates an embodiment of a web page. In some embodiments, web page 200 is part of a web site. With respect to network environment 100 of FIG. 1, for example, web page 200 may be created by a web page designer 102, may be persisted in a database 106, and may be made available to a requesting computer 110 by an associated server 108. Web page 200 includes graphics and textual content, some of which include clickable links to other web pages or content. Specifically, web page 200 provides access to content associated with the topic “Island Music”. Web page 200 includes a navigation bar that provides links to other web pages that are dedicated to specific genres that are included in the comprehensive genre of island music. Moreover, web page 200 includes lists of albums and songs associated with island music. The albums and songs included in the lists, for example, may correspond to the current most popular albums and songs associated with island music, may correspond to the most popular albums and songs associated with island music over a prescribed period of time, may correspond to the personal favorites of the designer of web page 200, etc. In some embodiments, one or more elements of such lists comprise links. For example, clicking on a particular album element in the albums list may allow a user to listen to, purchase, and/or download one or more songs associated with that album, and similarly clicking on a particular song element in the songs list may allow a user to listen to, purchase, and/or download that song. Although not shown in the given example, a web page such as web page 200 may include other types of content, such as audio content, multimedia content, applets, etc.

Although web pages and browsers may be sometimes described, the techniques described herein are not limited to web pages or to web browsers. The techniques described herein may be employed to create any type of display page that can be rendered using any appropriate rendering application.

In some embodiments, the authoring of a display page (such as web page 200 of FIG. 2) includes coding the display page using XML. Although coding a display page using XML may be sometimes described herein, any other suitable language such as XHTML, HTML, etc., may be employed to code a display page. When authoring a display page, code may be directly written by the display page designer and/or portions of pre-existing code may be appropriately combined to generate the code for the display page. Writing and directly working with the code for an entire display page and/or components of the display page may entail a considerable amount of time, for example, due to the complexity of the code as well as due to the amount of time needed to test and debug the code. Moreover, considerable knowledge of the semantics of the associated language is required. Although writing custom code and/or employing pre-existing pieces of code may be used to create some display pages, using such techniques to build every new display page is not particularly scalable and optimal for quickly generating a new display page and may not even be feasible by someone who is not sufficiently proficient with the associated language. Although templates based upon code may be used to facilitate the process of creating display pages, the use of such templates still requires a code build, which takes time and may require some knowledge of the code, for example, if a problem is encountered during the build.

As is disclosed herein, the display page design and development process can be improved if the creation of a display page is at least in part decoupled from its underlying code and a build of the code so that a display page can be quickly generated and possibly created by someone with a lesser understanding of the semantics of the code. In some embodiments, the structure of a designed display page is decoupled from its associated content and used to create a page template that can subsequently be reused at least as a starting point to create another display page. Such a template includes one or more structural components or objects of the display page from which it was created. In some embodiments, a template includes the hierarchical object graph of the structural objects of the display page from which it was created. When an instance of a template is employed in the creation of a new display page, in some embodiments an interface is provided to enable the object graph associated with the instance of the template to be edited or modified to achieve the desired object graph of the new display page. For example, one or more structural objects included in the template object graph may be deleted, one or more structural objects that are not included in the template object graph but are predefined and supported may be added; one or more structural objects may be rearranged, the settings or attributes associated with one or more structural objects may be modified, one or more objects may be promoted to a higher level within the page structure hierarchy, etc., to generate the desired object graph of the new display page. In some embodiments, a library of built structural objects is available in an associated editing application so that a display page designer does not have to directly deal with the underlying code of structural objects or builds of the code but can simply manipulate an object graph that is comprised of existing structural objects. The structural objects of the object graph point to custom content selected by the display page designer. Since in some embodiments the structural objects referenced in a display page derived from a template as well as the content items associated with the structural objects of the display page are persisted in an associated database (such as database 106 of FIG. 1), a build of the display page is not required, resulting in a purely data or content-driven technique for creating a display page.

In some embodiments, a display page editing application facilitates the creation of display pages as well as templates of display pages. The editing application in some embodiments includes a catalog of built structural objects that are reusable and available to a user for defining the overall structure (i.e. object graph) of a desired display page. Examples of structural objects include, for instance, images, text boxes, buttons, navigation bars, tables, matrices, dividers, etc., and each structural object may include one or more configurable attributes, such as size, position, transparency, etc. The editing application in some embodiments supports the creation of new structural objects. For example, a display page designer may have the option to locally store and/or globally store in a shared location or library associated with the editing application (such as database 106 of FIG. 1) a new structural object created, for example, by writing custom code or modifying the code of an existing structural object, so that it can be reused.

In some embodiments, an editing application includes a set of reusable templates. In some embodiments, an editing application has an option which when selected creates a template (i.e. object graph of structural objects) of a display page and stores it locally and/or globally so that it can be reused. A template may be generated for a display page created in any appropriate manner. For example, a display page may be created by at least partially custom coding the display page, for example, using XML; a display page may be created using one or more pre-existing structural objects; a display page may be created from a pre-existing although potentially modified template, etc. A template includes one or more structural objects, which collectively define the structure of the display page. In some embodiments, a template object graph is highly flexible and subject to modification through the manipulation of its structural objects.

Each of at least a subset of structural objects included in an object graph includes a pointer to a content item that hydrates the structural object when it is rendered. A content item may comprise, for example, text, graphics, a link to another content item or to a file, etc. In some embodiments, a content item may be custom coded. In some embodiments, an editing application includes the dynamic rendering of a display page as the content or data associated with each structural object is specified. That is, the editing application may include WYSIWIG (What You See Is What You Get) rendering. In some embodiments, when editing and/or rendering using a web browser or other rendering application, a mapping application is employed to convert the code associated with structural objects and/or content from a language (e.g., XML) that cannot be rendered directly in a web browser or other rendering application into a language that can be rendered (e.g., HTML).

With respect to FIG. 2, web page 200 may be created, for example, by custom coding, by using one or more existing structural objects, and/or by using and potentially modifying an instance of an existing template. In some embodiments, portions of web page 200 are dynamically rendered as content associated with the various structural objects are specified or populated at the corresponding referenced locations. Once a display page has been created, its structure may be saved and stored as a template, if desired. For example, a template of web page 200 may be useful for creating some of the web pages that can be navigated from web page 200. For instance, it may be desirable for the web pages associated with the sub-genres of “Island Music” (i.e., Reggae, Ska, Calypso, etc.) to which one could navigate from web page 200 to have exactly the same page layout as the main island music web page 200 with the exception of the elements of the albums and songs lists, which can be customized for each sub-genre. However, a template of a web page or other type of display page is not limited to be used only for creating web pages associated with a web site but may be used to create any web page associated with any web site or any other type of display page.

FIG. 3 illustrates an embodiment of a process for creating a template of a display page. In some embodiments, process 300 is employed by a display page editing application. Process 300 begins at 302 at which an indication to generate a template of a display page is received. At 304, the structure of the associated display page is determined. In some embodiments, at 304 the structure of the associated display page is determined programmatically at least in part by walking an object graph of structural objects comprising the page, identifying each node in the graph and its place in the structural hierarchy of the page, and ignoring display page specific content associated with each node, e.g., a stored content item to which a structural object points. At 306, the structure of the associated display page is stored for later use, and process 300 ends. In some embodiments, the structure (i.e. template) of the display page stored at 306 comprises a hierarchical object graph of structural objects of the display page. In some embodiments, 306 includes storing the structure in a database accessible by one or more display page designers. In some embodiments, 306 is (or may optionally be) omitted and the structure determined at 304 is used directly to create an instance of a new page based on the structure determined at 304.

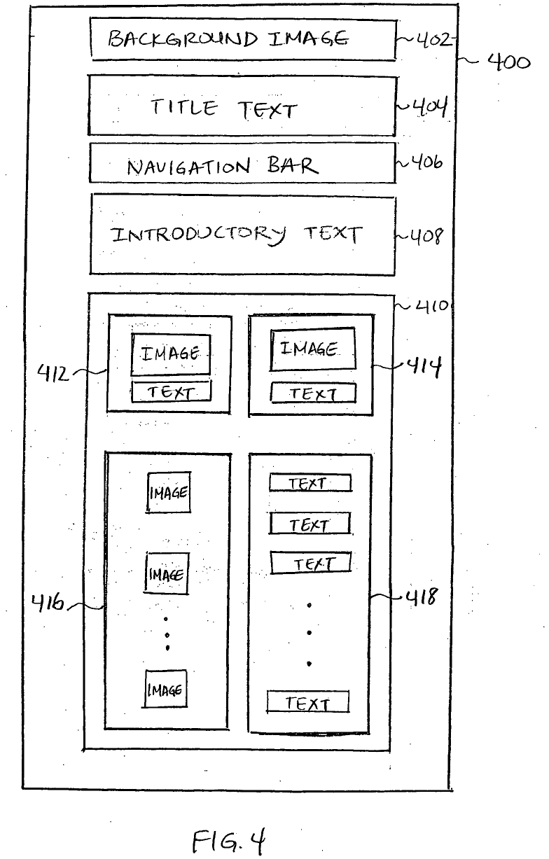

FIG. 4 illustrates an embodiment of a template of web page 200 of FIG. 2 in a graphical manner. In some embodiments, template 400 is generated by applying process 300 of FIG. 3 on web page 200 of FIG. 2. As depicted, template 400 includes structural objects but not corresponding content of web page 200. Specifically, template 400 includes the following structural objects: a background image structural object 402, which in web page 200 points to a content item associated with an image of a palm tree; a title text structural object 404, which in web page 200 points to a content item associated with the text “Island Music”; a navigation bar structural object 406, which in web page 200 points to one or more content items associated with text links “Main”, “Reggae”, “Ska”, “Calypso”, “Zouk”, “Salsa”, and “More”; an introductory text structural object 408, which in web page 200 points to a content item associated with the text “Be transported to the Caribbean . . . ”; and a four cell matrix structural object 410. Each of the four cells of matrix structural object 410 includes a view structural object. As used herein, the term “view object” refers to a type of structural object that contains one or more other structural objects. Specifically, matrix 410 includes: an upper left view object 412 comprising a background image structural object and a text heading structural object, which in web page 200 point to content items associated with an image of a coconut and the text “Albums”, respectively; an upper right view object 414 comprising a background image structural object and a text heading structural object, which in web page 200 point to content items associated with an image of a coconut and the text “Songs”, respectively; a lower left view object 416 comprising a group of image structural objects, which in web page 200 point to content items associated with clickable images of album cover art; and a lower right view object 418 comprising a group of text box structural objects, which in web page 200 point to content items associated with clickable song titles. Each of structural objects 402-418 may include one or more settings or attributes. In various embodiments, one or more of the items shown in FIG. 4 may include additional and/or more complex structures, such as associated hyperlinks, Java or other scripts, etc. For example, in an online music store website, a page such as the one represented in FIG. 2 may be configured to enable a user viewing the page to click through to related pages offering more and/or related information, the ability to purchase an item through an electronic commerce transaction, etc.

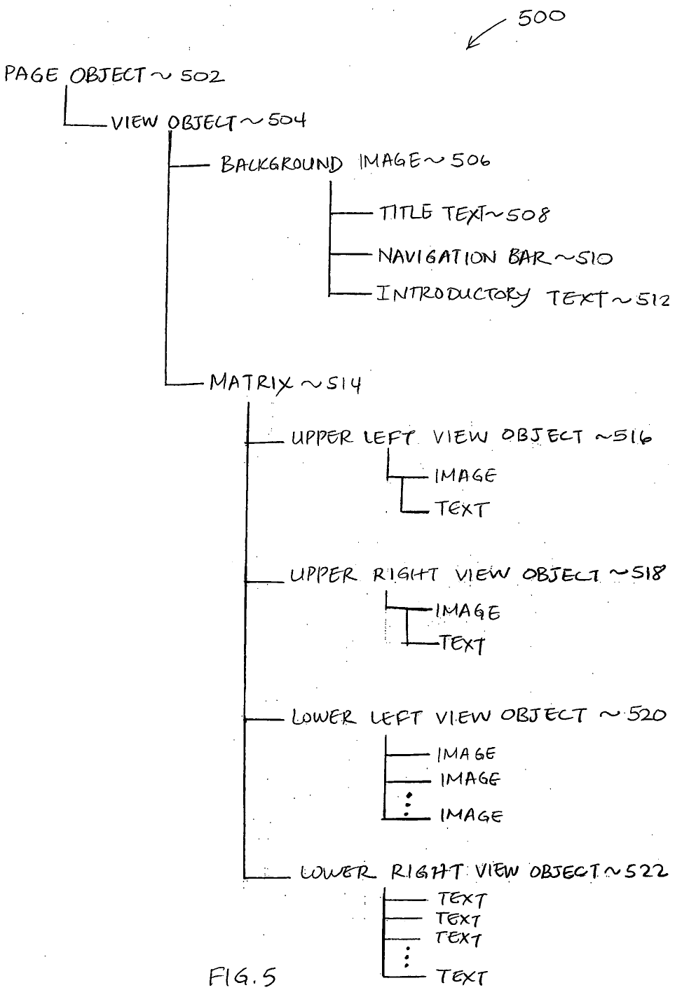

FIG. 5 illustrates an embodiment of a hierarchical object graph of web page 200 of FIG. 2. In some embodiments, object graph 500 is generated by applying process 300 of FIG. 3 on web page 200 of FIG. 2. As depicted, object graph 500 includes structural objects of web page 200 without the associated content from web page 200. Page object 502 corresponds to the root of object graph 500, under which exists a view object 504. The objects 506-522 under view object 504 correspond to the structural objects that are included in page object 502. Each of structural objects 506-522 may include one or more settings or attributes. For example, the background structural object 506 may include size, position, and transparency attributes, values for which may be selected by a designer. The definition (e.g., type) and attributes of each of the structural objects 506-522 are persisted in an associated database (such as database 106 of FIG. 1). When a display page is created using pre-built and stored structural objects, a build of the associated code is not required, and the creation of the display page depends only on the specification of the content items to which the associated structural objects refer. In the example shown in FIG. 5, structural objects 506-522 correspond to structural objects 402-418 of FIG. 4, respectively.

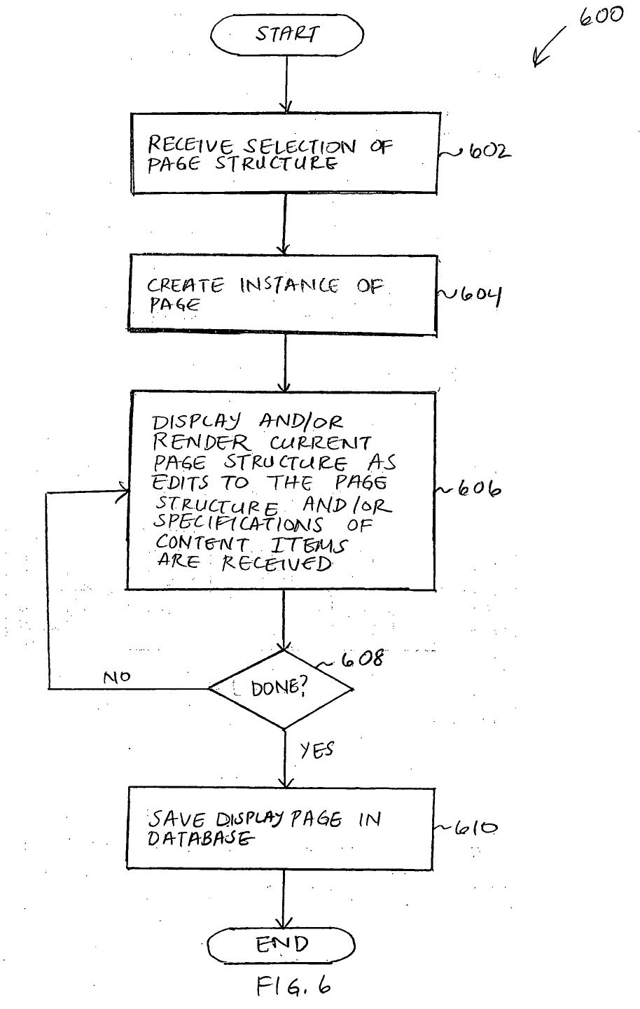

FIG. 6 illustrates an embodiment of a process for creating an instance of a display page from a template. In some embodiments, process 600 is employed by an editing application during a display page design and development process by a display page designer such as 102 of FIG. 1. In some embodiments, process 600 is employed to create a display page such as display page 200 of FIG. 2. Process 600 begins at 602 at which a selection of a page structure is received. In various embodiments, 602 includes receiving a selection of a previously stored template and/or receiving an indication that the structure of a previously-created page, the structure of which has not yet been stored as a template, is desired to be used. At 604, an instance of a page having the page structure selected at 602 is created. At 606, the current page structure is displayed and/or rendered as edits to the page structure and/or specifications of content items are received. In some embodiments, a graphical representation of the page structure is displayed at 606, e.g., in a manner similar to 400 of FIG. 4. In some embodiments, a hierarchical object graph associated with the page structure is displayed at 606, e.g., in a manner similar to 500 of FIG. 5. In some embodiments, 606 includes rendering in a display pane or window a graphical representation of the display page as it will/would appear to a user viewing the page using a browser software or other rendering application and rendering in an editing pane or window a designer-editable hierarchical object graph such as 500 of FIG. 5. In some embodiments, 606 includes receiving, e.g., via an editing interface, changes to the display page, implementing the changes in the instance created at 604, and updating a graphical display of the display page to reflect the change. At 608 it is determined whether the display page design is complete. If it is determined at 608 that the display page design is not complete, process 600 returns to 606 at which the most current page structure is displayed and/or rendered as changes in the page structure and/or content item specifications are detected. If it is determined at 608 that the display page design is complete, at 610 the display page is saved in an associated database (e.g., database 106 of FIG. 1) or other storage location, and process 600 ends. In some embodiments, 610 includes generating if an indication is received a template associated with the display page so that the underlying structure of the display page created using process 600 can be reused.

As described herein, creating templates of display pages so that they can be reused as well as defining a set of reusable structural objects that can be used and/or manipulated within the templates permits display pages with custom content to be created quickly (e.g., possibly without a build of the display page code if only pre-built structural components are employed) and perhaps by someone with limited knowledge of the underlying code. Although a display page designer may choose to include custom code when creating a display page, in the simplest case, a display page is completely created using an existing template and/or one or more existing structural objects, and the display page designer simply specifies the custom content referenced by the structural objects that define the display page.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for creating a display page, comprising:
creating an instance of a display page led at least in part on a display page structure derived from a previously-created display page at least in part by extracting from the previously-created display page one or more structural objects of the previously-created display page and one or more structural relationships between them, but not corresponding content of the previously-created display page; and
providing an editing interface configured to enable the instance of the display page to be edited at least in part by manipulating, within a graphical representation of a current structure of the display page, a graphical representation of a structural object comprising the display page.

2. A method as recited in claim 1, further comprising receiving a selection of the display page structure.

3. A method as recited in claim 1, wherein manipulating includes dragging or otherwise moving the graphical representation of the structural object comprising the display page to a desired new location within the graphical representation of the current structure of the display page; deleting the structural object from the graphical representation of the current structure of the display page; adding the structural object to the graphical representation of the current structure of the display page; linking a stored content item with the structural object comprising the display page; and editing an attribute of the structural object comprising the display page.

4. A method as recited in claim 1, further comprising receiving via the editing interface an indication of a desired change to the instance of the display page.

5. A method as recited in claim 4, further comprising implementing the desired change to the instance of the display page.

6. A method as recited in claim 1, wherein a structural object points to one or more content items.

7. A method as recited in claim 1, further comprising receiving one or more specifications of content items associated with the instance of the display page structure.

8. A method as recited in claim 1, further comprising rendering the instance of the display page.

9. A method as recited in claim 8, wherein rendering the instance of the display page comprises rendering the instance of the display page in real time.

10. A method as recited in claim 8, wherein rendering the instance of the display page comprises rendering the instance of the display page using a WYSIWIG (What You See Is What You Get) editor.

11. A method as recited in claim 1, wherein a structural object comprises one or more of the following: an image, text box, button, navigation bar, table, matrix, divider, and view object.

12. A method as recited in claim 1, wherein a structural object includes one or more attributes.

13. A method as recited in claim 1, wherein a structural object points to one or more content items and wherein a content item includes one or more of the following: text, graphics, and a link.

14. A method as recited in claim 1, wherein the display page structure comprises a template.

15. A method as recited in claim 1, wherein the display page structure comprises a hierarchical object graph of structural objects.

16. A method as recited in claim 1, wherein the display page structure is stored in a database.

17. A method as recited in claim 1, wherein the display page structure is coded in XML.

18. A method as recited in claim 1, wherein a display page comprises a web page.

19. A method for creating a reusable display page structure, comprising:
determining a structure of a first display page; and
saving the structure in a database to make the structure available for reuse to create a second display page.

20. A method as recited in claim 19, wherein the structure comprises a template.

21. A method as recited in claim 19, wherein the structure comprises a hierarchical object graph of structural objects

22. A system for creating a display page, comprising:
a processor configured to:
create an instance of a display page based at least in part on a display page structure derived from a previously-created display page at least in part by extracting from the previously-created display page one or more structural objects of the previously-created display page and one or more structural relationships between them, but not corresponding content of the previously-created display page; and
enable the instance of the display page to be edited at least in part by manipulating, within a graphical representation of a current structure of the display page, a graphical representation of a structural object comprising the display page; and
a memory coupled to the processor and configured to provide instructions to the processor.

23. A system as recited in claim 22, wherein manipulating includes dragging or otherwise moving the graphical representation of the structural object comprising the display page to a desired new location within the graphical representation of the current structure of the display page; deleting the structural object from the graphical representation of the current structure of the display page; adding the structural object to the graphical representation of the current structure of the display page; linking a stored content item with the structural object comprising the display page; and editing an attribute of the structural object comprising the display page.

24. A system as recited in claim 22, wherein the processor is further configured to receive an indication of a desired change to the instance of the display page and implement the desired change to the instance of the display page.

25. A system as recited in claim 22, wherein a structural object points to one or more content items.

26. A system as recited in claim 22, wherein the processor is further configured to render the instance of the display page.

27. A system as recited in claim 22, wherein the display page structure comprises a template.

28. A system as recited in claim 22, wherein the display page structure comprises a hierarchical object graph of structural objects.

29. A system as recited in claim 22, wherein the display page structure is coded in XML.

30. A computer program product for creating a display page, the computer program product being embodied in a computer readable medium and comprising computer instructions for:
creating an instance of a display page based at least in part on a display page structure derived from a previously-created display page at least in part by extracting from the previously-created display page one or more structural objects of the previously-created display page and one or more structural relationships between them, but not corresponding content of the previously-created display page; and
providing an editing interface configured to enable the instance of the display page to be edited at least in part by manipulating, within a graphical representation of a current structure of the display page, a graphical representation of a structural object comprising the display page.
